(19) United States
(12) Patent Application Publication
(10) Pub. No.: US 2026/0014549 A1
(43) Pub. Date: Jan. 15, 2026

(54) High Oxygen Storage Capacity Cerium and Zirconium Containing Oxide

(71) Applicant: Neo Performance Materials (Singapore) Pte. Ltd., Singapore (SG)

(72) Inventors: Barry HUANG, Singapore (SG); Benedict HSU, Singapore (SG); Szu Hwee NG, Singapore (SG)

(73) Assignee: Neo Performance Materials (Singapore) Pte. Ltd., Singapore (SG)

(21) Appl. No.: 18/926,756

(22) PCT Filed: Mar. 25, 2024
(86) PCT No.: PCT/IB2024/000140

§ 371 Date: Oct. 25, 2024

Related U.S. Application Data
(60) Provisional application No. 63/492,135, filed on Mar. 24, 2023.

(51) Int. Cl. B01J 23/10; B01J 23/00; B01J 37/00; B01J 37/03; B01J 37/06; B01J 37/08; B01J 37/12

(52) U.S. Cl. CPC B01J 23/10; B01J 23/002; B01J 37/009; B01J 37/031; B01J 37/06; B01J 37/08; B01J 37/12; B01J 2523/36; B01J 2523/3706; B01J 2523/3712; B01J 2523/3718; B01J 2523/3725; B01J 2523/48

(57) ABSTRACT

Disclosed herein are compositions having enhanced oxygen storage capacity (OSC). The high OSC compositions contain zirconium oxide, cerium oxide, and optionally one or more rare earth oxides other than cerium. These optional additional rare earth oxides may be yttrium oxide, lanthanum oxide, neodymium oxide, praseodymium oxide, or mixtures thereof. These compositions have an oxygen storage capacity of about 40 μmol-O₂/g to about 300 μmol-O₂/g after calcining at a temperature of about 900° C. in air for about 5 hours. Further disclosed are processes of producing these compositions having enhanced oxygen storage capacity (OSC). The compositions may be used as catalytic carriers or as part of a catalyst system.

### CROSS-REFERENCE OF RELATED APPLICATIONS

This application is being filed on 25 Mar. 2024 (24 Mar. 2024 falling on a Sunday), as a PCT International Patent Application and claims priority to and the benefit of U.S. Provisional Patent Application No. 63/492,135 filed on 24 Mar. 2023, the disclosure of which is hereby incorporated by reference in its entirety.

### FIELD OF THE INVENTION

This application relates to compositions comprising zirconium oxide, cerium oxide, and optionally one or more rare earth oxides other than cerium, wherein the composition exhibits a high Oxygen Storage capacity. These mixed oxide compositions surprisingly exhibit enhanced oxygen storage capacity (OSC), even after aging at elevated temperatures. The application further relates to processes of producing these compositions and uses for the same.

### INTRODUCTION

Oxygen storage/release (OSC) capacity is an important feature for many catalysts. For example, catalysts for purifying vehicle exhaust gas are composed of catalytic materials that have properties of absorbing oxygen under the oxidizing atmosphere and desorbing oxygen under the reducing atmosphere. With this oxygen absorbing and desorbing capability, the materials purify noxious components in exhaust gas such as hydrocarbons, carbon monoxide, and nitrogen oxides at excellent efficiency. These catalysts are able to oxidize carbon monoxide and hydrocarbons present in exhaust gases and also reduce nitrogen oxides present in the exhaust gases. As such, these catalytic materials are used mainly for catalytic converters in vehicles to purify exhaust gases.

In general, the catalytic material is required to have a sufficiently large specific surface area and a sufficiently high oxygen absorbing and desorbing capability, even at elevated temperatures. Cold start emissions represent the most toxic segment of the engine operating cycle. Further, more than 70 percent of all harmful gas emissions from a single average drive originates during a vehicle cold-start. Catalysts with lower light-off temperatures can remove engine exhaust gases more effectively at the initial stage of the engine starting. High oxygen storage capacity at low temperature (e.g., 400°) indicates a better catalyst light-off temperature. Having a high oxygen storage capacity catalyst at a low temperature, also produces a better catalyst light-off temperature. As hybrid internal combustion/electric vehicles become more abundant, it is increasingly important to develop catalytic materials with improved oxygen storage capacity (OSC) characteristics at low temperatures to handle increased on/off cycling and improved conversion of cold start hydrocarbons while maintaining industry standard high temperature performance and emissions control.

Therefore, developing compositions having high oxygen storage capacities and simple and efficient methods to prepare these high oxygen storage capacity compositions with higher thermal stability remains a need.

### SUMMARY

Disclosed herein are compositions comprising zirconium oxide, cerium oxide, and optionally one or more rare earth oxides other than cerium, wherein the composition exhibits an Oxygen Storage capacity of about 40 μmol-O₂/g to about 300 μmol-O₂/g after calcining (i.e., thermally treating) at a temperature of about 900° C. in air for about 5 hours. In one embodiment, the optional rare earth oxides can be selected from the group consisting of La₂O₃, Y₂O₃, Nd₂O₃, Pr₂O₃, and mixtures thereof.

In some embodiments, the compositions consist essentially of zirconium oxide, cerium oxide, and one or more of yttrium oxide, lanthanum oxide, neodymium oxide, and praseodymium oxide, wherein the composition exhibits an Oxygen Storage capacity of about 40 μmol-O₂/g to about 300 μmol-O₂/g after calcining (i.e., thermally treating) at a temperature of about 900° C. in air for about 5 hours.

Also disclosed herein is a process of producing oxide compositions with high Oxygen Storage capacity comprising: (a) mixing an aqueous oxalic acid solution with a zirconium salt solution, a cerium salt solution, and optionally rare earth salt solutions other than cerium to provide a precursor solution; (b) adding an oxidizing agent to the precursor solution; (c) adding ammonium hydroxide to form a precipitant and autoclaving the precipitant; (d) dispersing the precipitant in glycol ethers; and (e) calcining (i.e., thermally treating) the precipitate to provide an oxide composition comprising zirconium oxide, cerium oxide, and optionally one or more rare earth oxides other than cerium and having high Oxygen Storage capacity.

### BRIEF DESCRIPTION OF THE DRAWINGS

FIG. 1 illustrates a flowchart of the prior art as exemplified in Comparative Example 1.

FIG. 2 illustrates a flowchart of an embodiment of the process of making an oxygen storage capacity enhanced cerium and zirconium containing oxide as disclosed herein.

### DETAILED DESCRIPTION

This disclosure generally relates to mixed oxide composition containing zirconium and cerium exhibiting surprisingly enhanced/high oxygen storage capacity (OSC), both as prepared (i.e., fresh) and after aging at elevated temperatures.

Before the compositions comprising zirconium oxide and cerium oxide and having high Oxygen Storage capacity and the processes for making same are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

The present application relates to compositions containing zirconium oxide and cerium oxide and having enhanced oxygen storage capacity (OSC). These compositions also may contain one or more rare earth oxides other than cerium. With regard to enhanced oxygen storage capacity, the compositions as disclosed herein have an Oxygen Storage capacity of about 40 μmol-O₂/g to about 300 μmol-O₂/g after calcining (i.e., thermally treating) at a temperature of about 900° C. in air for about 5 hours.

The compositions as disclosed herein comprise zirconium oxide, cerium oxide, and optionally one or more rare earth oxides other than cerium, wherein the composition exhibits an Oxygen Storage capacity of about 40 μmol-O₂/g to about 300 μmol-O₂/g after calcining (i.e., thermally treating) at a temperature of about 900° C. in air for about 5 hours.

In certain embodiments, the compositions as disclosed herein have an Oxygen Storage capacity (OSC) of about 42 μmol-O₂/g to about 250 μmol-O₂/g after calcining (i.e., thermally treating) at a temperature of about 900° C. in air for about 5 hours and in other embodiments, the compositions as disclosed herein have an Oxygen Storage capacity of about 42 μmol-O₂/g to about 125 μmol-O₂/g after calcining (i.e., thermally treating) at a temperature of about 900° C. in air for about 5 hours. In certain embodiments, the compositions as disclosed herein have an Oxygen Storage capacity of about 42 μmol-O₂/g to about 80 μmol-O₂/g after calcining (i.e., thermally treating) at a temperature of about 900° C. in air for about 5 hours. It is noted that these calcining/thermally treating temperatures for OSC are the calcining/thermal treatment used in the processes for making the compositions as disclosed herein. As such, these OSC characteristics are of the compositions as prepared or “fresh”.

Oxygen storage capacity is performed in a Micrometrics Autochem 2920 system. The samples are subjected to pre-treatment in which the temperature is first raised to 400° C. under the flow of 50 cm³/min He gas, then subjected to ten-time pulse application of 10% O₂/He, followed by another twenty-time pulse application of 10% CO/He while being kept at 400° C. Thereafter, the samples are subjected to pulse application of 10% O₂/He until saturation is reached and the oxygen storage capacity is measured by the cumulative quantity of O₂ absorbed at 400° C.

In certain embodiments, the compositions as disclosed herein may undergo further calcining (i.e., aging). In these embodiments, when further calcined or aged, the composition exhibits an OSC of about 21 μmol-O₂/g to about 250 μmol-O₂/g after further calcining (i.e., aging) at a temperature of about 1000° C. in air for about 10 hours. In certain embodiments, when further calcined or aged, the composition exhibits an OSC of about 25 μmol-O₂/g to about 100 μmol-O₂/g after further calcining (i.e., aging) at a temperature of about 1000° C. in air for about 10 hours. In further embodiments, when further calcined or aged, the composition exhibits an OSC of about 25 μmol-O₂/g to about 70 μmol-O₂/g after further calcining (aging) at a temperature of about 1000° C. in air for about 10 hours.

In additional embodiments when calcined or aged further, the composition exhibits an OSC of about 10 μmol-O₂/g to about 200 μmol-O₂/g after further calcining (aging) at a temperature of about 1100° C. in air for about 10 hours. In certain embodiments, when further calcined or aged, the composition exhibits an OSC of about 10 μmol-O₂/g to about 100 μmol-O₂/g after further calcining (aging) at a temperature of about 1100° C. in air for about 10 hours. In further embodiments, when further calcined or aged, the composition exhibits an OSC of about 12.5 μmol-O₂/g to about 50 μmol-O₂/g after further calcining (aged) at a temperature of about 1100° C. in air for about 10 hours.

In another embodiment when calcined or aged further, the composition exhibits an OSC of about 6 μmol-O₂/g to about 150 μmol-O₂/g after further calcining (aging) at a temperature of about 1150° C. in air for about 5 hours. In certain embodiments, when further calcined or aged, the composition exhibits an OSC of about 6 μmol-O₂/g to about 80 μmol-O₂/g after further calcining (aging) at a temperature of about 1150° C. in air for about 10 hours. In further embodiments, when further calcined or aged, the composition exhibits an OSC of about 6 μmol-O₂/g to about 40 μmol-O₂/g after further calcining (aging) at a temperature of about 1150° C. in air for about 10 hours.

These further calcining treatments (i.e., aging treatments) are combined with the initial calcining at about 900° C. in air for about 5 hours either individually or cumulatively in any combination. The initial calcining is part of the process for preparing the compositions and the further calcining treatments (i.e., aging treatments) are to test the OSC capacity of the compositions simulating use.

For example, a single sample may be subjected to calcining at about 900° C. in air for about 5 hours (as part of the initial preparation process) and then at a temperature of about 1000° C. in air for about 10 hours. Or a single sample may be subjected to calcining at about 900° C. in air for about 5 hours and then at a temperature of about 1100° C. in air for about 10 hours. Or a single sample may be subjected to calcining at about 900° C. in air for about 5 hours and then at a temperature of about 1150° C. in air for about 10 hours. Or a single sample may be subjected to calcining at about 900° C. in air for about 5 hours and then at a temperature of about 1000° C. in air for about 10 hours and then at a temperature of about 1100° C. in air for about 10 hours. Or a single sample may be subjected to calcining at about 900° C. in air for about 5 hours and then at a temperature of about 1000° C. in air for about 10 hours and then at a temperature of about 1100° C. in air for about 10 hours and then at a temperature of about 1150° C. in air for about 10 hours.

In addition to zirconium oxide and cerium oxide, the compositions as disclosed herein optionally may also contain one or more rare earth oxides other than cerium. These additional and optional rare earths oxides include oxides of any of the rare earth elements other than cerium. The additional rare earth oxides can be selected from the group consisting of yttrium (Y), lanthanum (La), neodymium (Nd), praseodymium (Pr), samarium (Sm), europium (Eu), gadolinium (Gd), terbium (Tb), dysprosium (Dy), holmium (Ho), erbium (Er), thulium (Tm), ytterbium (Yb), lutetium (Lu), and mixtures thereof.

In particular embodiments, the additional one or more rare earth oxides are yttrium oxide, lanthanum oxide, neodymium oxide, praseodymium oxide or mixtures thereof. As such, the compositions comprise zirconium oxide and cerium oxide, and additional rare earth oxide selected from the group consisting of yttrium oxide, lanthanum oxide, neodymium oxide, praseodymium oxide, and mixtures thereof.

In certain embodiments, the compositions may contain zirconium oxide, cerium oxide, lanthanum oxide, and neodymium oxide. In other embodiments, the compositions may contain zirconium oxide, cerium oxide, lanthanum oxide, and yttrium oxide. In additional embodiments, the compositions may contain zirconium oxide, cerium oxide, lanthanum oxide, neodymium oxide, and yttrium oxide. In further embodiments, the compositions may contain zirconium oxide, cerium oxide, lanthanum oxide, and praseodymium oxide.

The compositions can contain about 15 wt % to about 60 wt % cerium oxide and about 40 wt % to about 85 wt % zirconium oxide based on the total weight of the composition and optionally one or more rare earth oxides other than cerium. In certain embodiments, the compositions contain one or more of the rare earth oxides yttrium oxide, lanthanum oxide, neodymium oxide, praseodymium oxide or mixtures thereof. In these embodiments, the one or more additional rare earth oxides may be present in an amount of about 2 wt % to about 15 wt % based on the total weight. In certain embodiments, the one or more additional rare earth oxides may be present in an amount of about 5 wt % to about 12 wt % based on the total weight. In particular embodiments, the one or more additional rare earth oxides may be present in an amount of about 7 wt % to about 10 wt % based on the total weight.

These oxide compositions as disclosed herein may contain trace amounts of impurities. These impurities are typically present in an amount of about 1% by weight or less (to about zero or to an amount that is undetectable) based on the total weight of the mixed oxide composition. These impurities include residual solvents, salts, other metals, and the like. These other metals include those commonly found in water, such as magnesium, iron, calcium, silicon, sodium, and the like. These impurity amounts (of about 1% by weight to about zero or to an amount that is undetectable) may be present in any of the described embodiments of the mixed oxide compositions. When present and detectable, any impurities may be present in an amount of about 100 ppm or less.

In an embodiment, the compositions as disclosed herein consist essentially of zirconium oxide, cerium oxide, and one or more of yttrium oxide, lanthanum oxide, neodymium oxide, and praseodymium oxide, wherein the composition exhibits an Oxygen Storage capacity of about 40 μmol-O₂/g to about 300 mol-O₂/g after calcining at a temperature of about 900° C. in air for about 5 hours.

In particular embodiments, the composition contains zirconium oxide, cerium oxide, lanthanum oxide, and neodymium oxide. In this embodiment, the composition may have a ratio of Ce/Zr/La/Nd of approximately 71.2 wt % ZrO₂ to approximately 73.2 wt % ZrO₂, approximately 20.1 wt % CeO₂ to approximately 21.5 wt % CeO₂, approximately 1.2 wt % La₂O₃ to approximately 2.2 wt % La₂O₃, and approximately 4.8 wt % Nd₂O₃ to approximately 5.8 wt % Nd₂O₃ on an equivalent oxide basis.

In another embodiment, the composition contains zirconium oxide, cerium oxide, lanthanum oxide, and yttrium oxide. In this embodiment, the composition may have a ratio of Zr/Ce/La/Y of approximately 66.5 wt % ZrO₂ to approximately 68.5 wt % ZrO₂, approximately 24 wt % CeO₂ to approximately 26 wt % CeO₂, approximately 3 wt % La₂O₃ to approximately 4 wt % La₂O₃ and approximately 3.5 wt % Y₂O₃ to approximately 4.5 wt % Y₂O₃ on an equivalent oxide basis.

In yet another embodiment, the composition contains zirconium oxide, cerium oxide, lanthanum oxide, neodymium oxide, and yttrium oxide. In this embodiment, the composition may have a ratio of Zr/Ce/La/Nd/Y of approximately 49 wt % ZrO₂ to approximately 51 wt % ZrO₂, approximately 39 wt % CeO₂ to approximately 41 wt % CeO₂, approximately 3.5 wt % La₂O₃ to approximately 4.5 wt % La₂O₃, approximately 3.5 wt % Nd₂O₃ to approximately 4.5 wt % Nd₂O₃ and approximately 1.8 wt % Y₂O₃ to approximately 2.2 wt % Y₂O₃ on an equivalent oxide basis.

In another embodiment, the composition contains zirconium oxide, cerium oxide, lanthanum oxide, and praseodymium oxide. In this embodiment, the composition may have a ratio of Zr/Ce/La/Pr of 49 wt % ZrO₂ to approximately 51 wt % ZrO₂, approximately 39 wt % CeO₂ to approximately 41 wt % CeO₂, approximately 4.75 wt % La₂O₃ to approximately 5.25 wt % La₂O₃, and approximately 4.75 wt % Pr₂O₃ to approximately 5.25 wt % Pr₂O₃ on an equivalent oxide basis.

The compositions of the present disclosure may include additional ratios of zirconium oxide, cerium oxide, and one or more oxides of lanthanum, neodymium, praseodymium, and yttrium.

The enhanced oxygen storage capacity makes these compositions particularly suitable for use in catalysis as part of a catalyst system or as catalytic carriers. The catalysts are used in vehicles to purify exhaust gases, and for other related uses. When used as a catalyst carrier or as part of a catalyst system, the catalyst compositions additionally comprise platinum group metals (PGM). The Platinum Group Metals (PGM) are selected from group consisting of platinum, palladium, rhodium, iridium, osmium, ruthenium, and mixtures thereof.

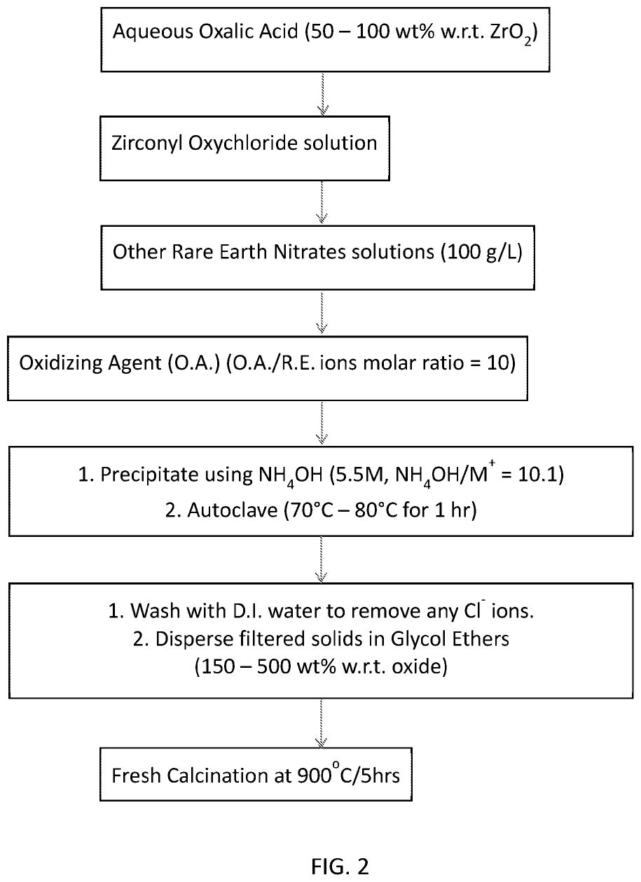

The compositions having enhanced OSC as disclosed herein are made by a particular process that provides the compositions with an Oxygen Storage capacity of about 40 μmol-O₂/g to about 300 μmol-O₂/g after calcining at a temperature of about 900° C. in air for about 5 hours. FIG. 2 is a flow chart for an embodiment of a process of preparing these compositions having enhanced OSC.

The process includes steps of (a) mixing an aqueous oxalic acid solution with a zirconium salt solution, a cerium salt solution, and optionally rare earth salt solutions other than cerium to provide a precursor solution; (b) adding an oxidizing agent to the precursor solution; (c) adding ammonium hydroxide to form a precipitate and autoclaving the precipitate; (d) dispersing the precipitate in glycol ethers; and (e) calcining or thermally treating the precipitate to provide an oxide composition comprising zirconium oxide, cerium oxide, and optionally one or more rare earth oxides other than cerium and having a high oxygen storage capacity.

An aqueous oxalic acid solution is mixed with a zirconium salt solution, a cerium salt solution, and optionally rare earth salt solutions to provide a precursor solution. The zirconium salt, cerium salt, and optional additional rare earth salts are water soluble, and in the process, the salts are dissolved in the water before mixing with the aqueous oxalic acid solution. The salts may be of inorganic or organic acids, for example chloride, sulfate, nitrate, acetate, and the like that are water soluble. In certain embodiments, a zirconyl oxychloride solution is used. In certain embodiments, the rare earth salts can be either a chloride or nitrate salt. As described herein, the additional rare earth may be Pr, La, Nd, Y, or mixtures thereof.

The aqueous oxalic acid is mixed in an amount of approximately 50 to approximately 100% by weight with respect to the zirconium oxide content. The rare earth salt solutions, including the cerium salt solution and optional rare earth salt solutions, may have a rare earth concentration of about 10 g/L to about 150 g/L and in certain embodiments, about 100 g/L. The precursor solution of step (a) can have an oxide concentration of approximately 50 g/L to about 100 g/L.

The order of addition of adding the oxalic acid solution, the zirconium salt solution, the cerium salt solution, and the one or more rare earth salt solutions other than cerium, to provide the precursor solution of step (a) is not important and any addition order may be utilized, or all may be added together simultaneously. Further, the rate of addition is not important. In certain embodiments, an aqueous oxalic acid solution is prepared and a mixture comprising oxalic acid and zirconium salt solution can be formed. The rare earth salt solutions can then be added to provide the precursor solution.

The oxidizing agent is added to the precursor solution formed in step (a). The oxidizing agent may be hypochlorite, sodium chlorate, ammonium perchlorate, ozone, hydrogen peroxide, or mixtures thereof. The oxidizing agent is added to provide an oxidizing agent to rare earth ion molar ratio of approximately 7 to approximately 12 and in certain embodiments approximately 8 to approximately 11. In other specific embodiments, the oxidizing agent is added to provide an oxidizing agent to rare earth ion molar ratio of approximately 10.

After the oxidizing agent is added, ammonium hydroxide is added to form a precipitate or the mixture including the oxidizing agent can be added to an ammonium hydroxide solution. The ammonium hydroxide utilized may be approximately 5 M to approximately 10 M and the ammonium hydroxide may be added in an amount of approximately 700 to approximately 1250% by weight with equivalent oxide content. The ratio of NH₄OH/M⁺ is approximately 10.1, where M+ is the total metal ions in the mixture.

The precipitate is then autoclaved. The precipitate may be autoclaved at a temperature of about 50° C. to about 100° C. and for about 45 mins to about 2 hours. In certain embodiments, the precipitate may be autoclaved at a temperature of about 70° C. to about 80° C. and for about 1 hours.

In certain embodiments, after the precipitate is autoclaved, the formed precipitate may be washed with deionized water to remove residual quantities of bound or adsorbed ions, such as nitrates and chlorides. In certain embodiments, the precipitate is particularly pure in anionic impurities, as characterized by a conductivity of less than about 10 mS/cm after washing. The precipitate may be isolated by filtration, such as vacuum filtration.

The precipitate is dispersed in the glycol ethers. The precipitate may be dispersed in an amount of glycol ethers that is about 150 wt % to about 500 wt % with respect to the oxide content. The glycol ethers have an evaporation rate of less than 0.05, a boiling point of greater than 230° C., a surface tension of less than 34 dynes/cm, and a water solubility of greater than 50 wt % at 25° C. In certain embodiments, the glycol ethers have an evaporation rate of about 0.0002 to about 0.005, a boiling point of about 230° C. to about 300° C., a surface tension of about 25 to about 34 dynes/cm, and a water solubility of about 50 wt % to about 100 wt % at about 25° C.

The precipitate is calcined or thermally treated. The calcining may be conducted at a temperature of from about 750° C. to about 1100° C. and for about 3 to 7 hours. In a specific embodiment, the calcining may be conducted at a temperature of about 900° C. for about 5 hours. Calcining after the above process steps provides the oxide compositions as described herein having an enhanced OSC.

The oxide compositions created by the process disclosed herein have an OSC of about 40 μmol-O₂/g to about 300 μmol-O₂/g after calcining at a temperature of about 900° C. in air for about 5 hours. This OSC is for the as prepared (fresh) composition.

The addition of an oxidizing agent in step (b) and dispersing the solids in glycol ethers distinguishes the present process and assists in producing the compositions as disclosed herein having enhanced oxygen storage capacities.

The following Examples are given to illustrate the inventive method for the preparation of the compositions having enhanced oxygen storage capacities and characterization thereof in more detail, although the scope of the invention is never limited thereby in any way.

In the Examples disclosed herein, the compositions were made and tested for total OSC. Characterization was performed in a Micrometrics Autochem 2920 system, where 0.1 g of the samples obtained in the Examples and Comparative Examples were weighed into a quartz sample tube with a packed quartz wool bed. The samples were then subjected to pre-treatment in which the temperature was first raised to 400° C. under the flow of 50 cm³/min He gas, then subjected to ten-time pulse application of 10% O₂/He, followed by another twenty-time pulse application of 10% CO/He while being kept at 400° C. Thereafter, the samples were subjected to pulse application of 10% O₂/He until saturation is reached and the oxygen storage capacity was measured by the cumulative quantity of O₂ absorbed at 400° C.

### Comparative Example 1: Oxide Composition of Zr/Ce/La/Nd=72.2/20.8/1.7/5.3

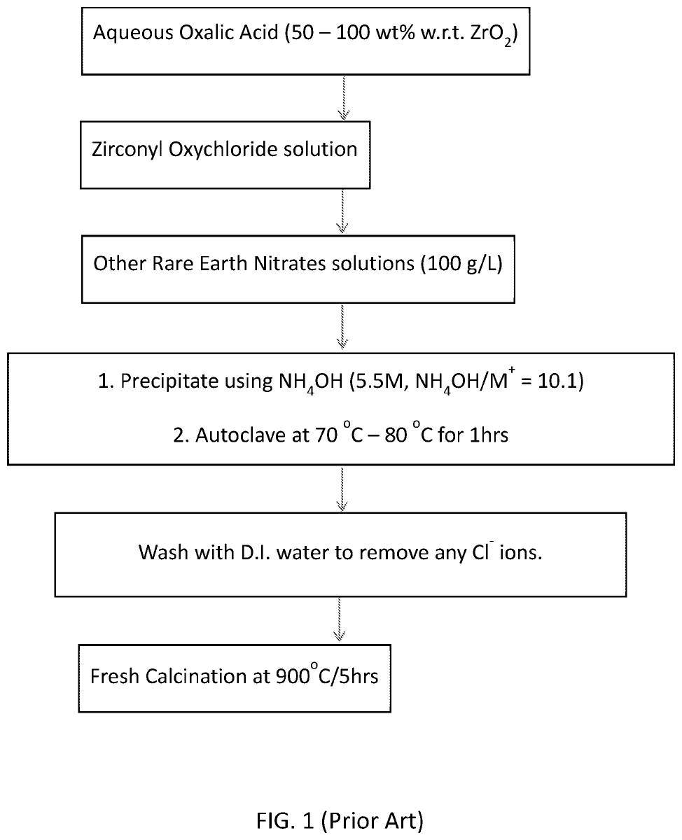

The following was done:
1) A mixed oxide with composition of oxide equivalent to 72.2 wt % ZrO₂, 20.8 wt % CeO₂, 1.7 wt % La₂O₃ and 5.3 wt % Nd₂O₃ was prepared.
2) Aqueous oxalic acid solution was mixed with zirconyl oxychloride solution.
3) A solution of cerium (III) nitrate, lanthanum nitrate and neodymium nitrate were combined with above mixture in appropriate ratios to achieve targeted elemental composition of zirconium, cerium, lanthanum and neodymium.
4) 273 mL of NH₄OH (5.5 M) was used to form a precipitate.
5) The precipitate was autoclaved for one hour.
6) The aged precipitate was washed with deionized water to remove any impurities.
7) The washed precipitate was filtered.
8) The filtered solids were calcined at 900° C. in air for 5 hours.
   The above prior art process is illustrated in FIG. 1.

### Example 1: Oxide Composition of Zr/Ce/La/Nd=72.2/20.8/1.7/5.3

The following was done:
1) A mixed oxide composition of oxides equivalent to 72.2 wt % ZrO₂, 20.8 wt % CeO₂, 1.7 wt % La₂O₃ and 5.3 wt % Nd₂O₃ was prepared.
2) Aqueous oxalic acid solution was mixed with zirconyl oxychloride solution.
3) A solution of cerium (III) nitrate, lanthanum nitrate and neodymium nitrate was combined with the above mixtures in appropriate ratios to achieve a targeted elemental composition of zirconium, cerium, lanthanum and neodymium.
4) 25 mL of a H₂O₂ solution (30 wt %) was added to the above mixture.
5) 273 mL of NH₄OH (5.5 M) was used to form a precipitate.
6) Precipitate was autoclaved for one hour.
7) The aged precipitate was washed with deionized water to remove any impurities.
8) The washed precipitate was filtered.
9) The filtered solids were dispersed in triethylene glycol ethyl ether.
10) The dispersed paste was calcined at 900° C. in air for 5 hours.

### Example 2: Oxide Composition of Zr/Ce/La/Y=67.5/25/3.5/4

The following was done:
1) A mixed oxide composition of oxides equivalent to 67.5 wt % ZrO₂, 25 wt % CeO₂, 3.5 wt % La₂O₃ and 4 wt % Y₂O₃ was prepared.
2) Aqueous oxalic acid solution was mixed with zirconyl oxychloride solution.
3) A solution of cerium (III) nitrate, lanthanum nitrate and yttrium nitrate was combined with the above mixtures in appropriate ratios to achieve a targeted elemental composition of zirconium, cerium, lanthanum and yttrium.
4) 19 mL of a H₂O₂ solution (35 wt %) was added to the above mixture.
5) 205 mL of NH₄OH (5.5 M) was used to form a precipitate.
6) The precipitate was autoclaved for one hour.
7) The aged precipitate was washed with deionized water to remove any impurities.
8) The washed precipitate was filtered.
9) The filtered solids were dispersed in tripropylene glycol methyl ether.
10) The dispersed paste was calcined at 900° C. in air for 5 hours.

### Example 3: Oxide Composition of Zr/Ce/La/Nd/Y=50/40/4/4/2

The following was done:
1) A mixed oxide composition of oxides equivalent to 50 wt % ZrO₂, 40 wt % CeO₂, 4 wt % La₂O₃, 4 wt % Nd₂O₃ and 2 wt % Y₂O₃ was prepared.
2) Aqueous oxalic acid solution was mixed with zirconyl oxychloride solution.
3) A solution of cerium (III) nitrate, lanthanum nitrate, neodymium nitrate and yttrium nitrate was combined with the above mixtures in appropriate ratios to achieve a targeted elemental composition of zirconium, cerium, lanthanum, neodymium and yttrium.
4) 71 mL of a H₂O₂ solution (30 wt %) was added to the above mixture.
5) 386 mL of NH₄OH (5.5 M) was used to form a precipitate.
6) The precipitate was autoclaved for one hour.
7) The aged precipitate was washed with deionized water to remove any impurities.
8) The washed precipitate was filtered.
9) The filtered solids were dispersed in triethylene glycol n-butyl ether.
10) The dispersed paste was calcined at 900° C. in air for 5 hours.

### Example 4: Oxide Composition of Zr/Ce/La/Pr=50/40/5/5

The following was done:
1) A mixed oxide composition of oxides equivalent to 50 wt % ZrO₂, 40 wt % CeO₂, 5 wt % La₂O₃, and 5 wt % Pr₂O₃ was prepared.
2) Aqueous oxalic acid solution was mixed with zirconyl oxychloride solution.
3) A solution of cerium (III) nitrate, lanthanum nitrate and praseodymium nitrate was combined with the above mixtures in appropriate ratios to achieve a targeted elemental composition of zirconium, cerium, lanthanum and praseodymium.
4) 47 mL of a H₂O₂ solution (30 wt %) was added to the above mixture.
5) 255 mL of NH₄OH (5.5 M) was used to form a precipitate.
6) The precipitate was autoclaved for one hour.
7) The aged precipitate was washed with deionized water to remove any impurities.
8) The washed precipitate was filtered.
9) The filtered solids were dispersed in diethylene glycol hexyl ether.
10) The dispersed paste was calcined at 900° C. in air for 5 hours.

### Summary of Oxygen Storage Capacity Results at 400° C.

The following table summarizes the oxygen storage capacity results at 400° C. for Examples 1-4 versus Comparative Example 1. The results confirm that the oxygen storage capacities of the Examples disclosed herein are significantly higher than the oxygen storage capacity of the comparative example made by a process disclosed in the prior art.

TABLE 1
Comparison of Oxygen Storage Capacity at 400° C.

| | | | Air aged | Air aged | Air aged |
|---|---|---|---|---|---|
| | | | 1000° C./ | 1100° C./ | 1150° C./ |
| | | Fresh* | 10 hrs | 10 hrs | 5 hrs |
| | | (μmol - | (μmol - | (μmol - | (μmol - |
| Ex. No. | Composition | O₂/g) | O₂/g) | O₂/g) | O₂/g) |
| 1 | Ce/Zr/La/Nd = | 42.5 | 26.7 | 13.0 | 6.0 |
| | 20.8/72.2/1.7/5.3 | | | | |
| 2 | Ce/Zr/La/Y = | 51.6 | 29.1 | 13.3 | 7.7 |
| | 25/67.5/3.5/4 | | | | |
| 3 | Ce/Zr/La/Nd/Y = | 60.4 | 53.1 | 35.9 | 21.9 |
| | 40/50/4/4/2 | | | | |
| 4 | Ce/Zr/La/Pr = | 57.4 | 48.4 | 28.7 | 13.5 |
| | 40/50/5/5 | | | | |
| CP 1 | Ce/Zr/La/Nd = | 31.4 | 18.2 | 6.5 | 5.3 |
| | 20.8/72.2/1.7/5.3 | | | | |

CP: Comparative
*calcined at 900° C. in air for 5 hours

As shown, the compositions comprising zirconium oxide, cerium oxide, and optionally one or more rare earth oxides other than cerium as disclosed herein exhibit an Oxygen Storage capacity of about 42.5 μmol-O₂/g and greater after calcining at a temperature of about 900° C. in air for about 5 hours. These high oxygen storage capacities are in contrast to the oxygen storage capacity of the comparative oxide. The higher oxygen storage capacities for the compositions as disclosed herein remain even after additional air aging/calcining at 1000° C. for 10 hrs, 1100° C. for 10 hrs, and 1150° C. for 10 hrs. With these higher oxygen storage capacities, the present compositions provide improve catalytic material for catalytic converters and vehicles to purify gases.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

1. A composition comprising zirconium oxide, cerium oxide, and optionally one or more rare earth oxides other than cerium, wherein the composition exhibits an Oxygen Storage capacity of about 40 μmol-O₂/g to about 300 μmol-O₂/g after calcining at a temperature of about 900° C. in air for about 5 hours.

2. A composition consisting essentially of zirconium oxide, cerium oxide, and one or more of yttrium oxide, lanthanum oxide, neodymium oxide, and praseodymium oxide, wherein the composition exhibits an Oxygen Storage capacity of about 40 μmol-O₂/g to about 300 μmol-O₂/g after calcining at a temperature of about 900° C. in air for about 5 hours.

3. The composition of claim 1, wherein the composition comprises CeO₂ and ZrO₂ and one or more of La₂O₃, Y₂O₃, Nd₂O₃, and Pr₂O₃.

4. The composition of claim 1, wherein the Oxygen Storage capacity of the oxide is about 21 μmol-O₂/g to about 250 μmol-O₂/g after further calcining at a temperature of about 1000° C. in air for about 10 hours.

5. The composition of claim 2, wherein the Oxygen Storage capacity is about 10 μmol-O₂/g to about 200 μmol-O₂/g after further calcining at a temperature of about 1100° C. in air for about 10 hours.

6. The composition of claim 1, wherein the Oxygen Storage capacity is about 6 μmol-O₂/g to about 150 μmol-O₂/g after further calcining at a temperature of about 1150° C. in air for about 5 hours.

7. The composition of claim 1 consisting essentially of CeO₂, La₂O₃, Nd₂O₃, and ZrO₂, wherein the ratio of Ce/Zr/La/Nd is approximately 71.22 wt % ZrO₂ to approximately 73.2 wt % ZrO₂, approximately 20.1 wt % CeO₂ to approximately 21.5 wt % CeO₂, approximately 1.2 wt % La₂O₃ to approximately 2.2 wt % La₂O₃, and approximately 4.8 wt % Nd₂O₃ to approximately 5.8 wt % Nd₂O₃ on an equivalent oxide basis.

8. The composition of claim 1 consisting essentially of CeO₂, La₂O₃, Y₂O₃, ZrO₂ wherein the ratio of Zr/Ce/La/Y is approximately 66.5 wt % ZrO₂ to approximately 68.5 wt % ZrO₂, approximately 24 wt % CeO₂ to approximately 26 wt % CeO₂, approximately 3 wt % La₂O₃ to approximately 4 wt % La₂O₃ and approximately 3.5 wt % Y₂O₃ to approximately 4.5 wt % Y₂O₃ on an equivalent oxide basis.

9. The composition of claim 1 consisting essentially of CeO₂, La₂O₃, Y₂O₃, Nd₂O₃, ZrO₂ wherein the ratio of Zr/Ce/La/Nd/Y is approximately 49 wt % ZrO₂ to approximately 51 wt % ZrO₂, approximately 39 wt % CeO₂ to approximately 41 wt % CeO₂, approximately 3.5 wt % La₂O₃ to approximately 4.5 wt % La₂O₃, approximately 3.5 wt % Nd₂O₃ to approximately 4.5 wt % Nd₂O₃ and approximately 1.8 wt % Y₂O₃ to approximately 2.2 wt % Y₂O₃ on an equivalent oxide basis.

10. The composition of claim 1 consisting essentially of CeO₂, La₂O₃, Pr₂O₃, ZrO₂ wherein the ratio of Zr/Ce/La/Pr is approximately 49 wt % ZrO₂ to approximately 51 wt % ZrO₂, approximately 39 wt % CeO₂ to approximately 41 wt % CeO₂, approximately 4.75 wt % La₂O₃ to approximately 5.25 wt % La₂O₃, and approximately 4.75 wt % Pr₂O₃ to approximately 5.25 wt % Pr₂O₃ on an equivalent oxide basis.

11. A process of producing oxides with high Oxygen Storage capacity comprising:
(a) mixing an aqueous oxalic acid solution with a zirconium salt solution, a cerium salt solution, and optionally rare earth salt solutions other than cerium to provide a precursor solution;
(b) adding an oxidizing agent to the precursor solution;
(c) adding ammonium hydroxide to form a precipitate and autoclaving the precipitate;
(d) dispersing the precipitate in glycol ethers; and
(e) calcining the precipitate to provide an oxide composition comprising zirconium oxide, cerium oxide, and optionally one or more rare earth oxides other than cerium and having high Oxygen Storage capacity.

12. The process of claim 11, wherein the oxide composition has an Oxygen Storage capacity of about 40 μmol-O₂/g to about 300 μmol-O₂/g after calcining at a temperature of about 900° C. in air for about 5 hours.

13. The process of claim 11, wherein the glycol ethers have an evaporation rate of about 0.0002 to about 0.005, a boiling point of about 230° C. to about 300° C., a surface tension of about 25 to about 34 dynes/cm, and a water solubility of about 50 wt % to about 100 wt % at about 25° C.

14. The process of claim 11, wherein the glycol ethers are added in an amount of approximately 150 to approximately 500% by weight with respect to equivalent oxide content.

15. The process of claim 11 wherein the oxidizing agent is selected from the group consisting of hypochlorite, sodium chlorate, ammonium perchlorate, ozone, hydrogen peroxide, and mixtures thereof.

16. The process of claim 15, wherein the oxidizing agent is added to provide an oxidizing agent to rare earth ion molar ratio of about 7 to about 12.

17. The process of claim 16, wherein the oxidizing agent is added to provide an oxidizing agent to rare earth ion molar ratio of about 10.

18. The process of claim 11, wherein in step (a) an aqueous oxalic acid, zirconyl oxychloride solution, cerium nitrate solution, and a rare earth nitrate solutions selected from the group consisting of yttrium, lanthanum, praseodymium, neodymium, and mixtures thereof are mixed.

19. The process of claim 11 further comprising washing the precipitate with deionized water before dispersing the precipitate in glycol ethers.

20. The process of claim 11, wherein the oxalic acid is mixed in an amount of approximately 50% to approximately 100% by weight with respect to equivalent zirconium oxide content.

21. The process of claim 11, wherein the ammonium hydroxide is approximately 5 M to approximately 10 M and the ammonium hydroxide is added in an amount of approximately 700% to approximately 1250% by weight with equivalent oxide content.

22. The process of claim 11, wherein the calcining is conducted at a temperature of about 750° C. to about 1100° C. and for about 3 to 7 hours.

23. The process of claim 22, wherein the calcining is conducted at a temperature of about 900° C. for about 5 hours.

24. The process of claim 22, wherein the autoclaving is at a temperature of about 50° C. to about 100° C. and for about 45 mins to about 2 hours.

25. The process of claim 11, wherein the precursor solution of step (a) has an oxide concentration of approximately 50 g/L to about 100 g/L.

26. An oxide composition made by the process of claim 11, wherein the oxide composition has an Oxygen Storage capacity of about 40 μmol-O₂/g to about 300 μmol-O₂/g after calcining at a temperature of about 900° C. in air for about 5 hours.

27. A catalyst composition comprising the composition of claim 1.
